(19) United States
(12) Patent Application Publication
(10) Pub. No.: US 2026/0292947 A1
(43) Pub. Date: Sep. 24, 2026

(54) PROJECTOR

(71) Applicant: SEIKO EPSON CORPORATION, Tokyo (JP)

(72) Inventor: Takeshi TAMURA, NAGANO-SHI (JP)

(21) Appl. No.: 19/571,580

(22) Filed: Mar. 19, 2026

(30) Foreign Application Priority Data
Mar. 21, 2025 (JP) 2025-046488

(51) Int. Cl. H05B 45/10; G03B 21/20

(52) U.S. Cl. CPC H05B 45/10; G03B 21/2053

(57) ABSTRACT

A projector includes a light source; a driver element configured to control the light source, an integrated circuit element configured to control the driver element, a main board on which the integrated circuit element is mounted, a touch sensor disposed inside an outer peripheral portion of the main board, a microcontroller that is disposed adjacent to the touch sensor and that is configured to control the touch sensor, a connector disposed on the main board at a position closer to the outer peripheral portion than the microcontroller and electrically connected to the integrated circuit element, and a connection board that mounts the microcontroller on one end side and that has a connection cable connected to the connector on the other end side, and that extends from the one end side toward the connector, wherein the connection board is non-flexible, and it does not overlap an electromagnetic interference object.

The present application is based on, and claims priority from JP Application Serial Number 2025-046488, filed Mar. 21, 2025, the disclosure of which is hereby incorporated by reference herein in its entirety.

### BACKGROUND

### Technical Field

The present disclosure relates to a projector.

### Related Art

JP-A-2004-144809 discloses an electronic device equipped with a projection lens that can prevent the metal cam cylinder from adversely affecting Electro Magnetic Interference (EMI: electromagnetic interference or electromagnetic disturbance) characteristics in a manner that is compatible with miniaturization and cost reduction of the electronic device equipped with a projection lens having a metal cam barrel.

In the projector, in a case where a microcontroller is connected to an integrated circuit element such as a System on a Chip (SoC) mounted on a main board, a connection member such as a cable or a wire harness is used. In this case, the connection member is bent and in contact with an electromagnetic interference object such as the integrated circuit element, a wireless module, or a coil, and thus, there is a problem in that the EMI characteristics are deteriorated.

### SUMMARY

To achieve the above objective, one aspect of the present disclosure includes a light source; a driver element configured to control the light source; an integrated circuit element configured to control the driver element; a main board on which the integrated circuit element is mounted; a sensor disposed inside an outer peripheral portion of the main board in plan view as viewed from an opposing direction that opposes the main board; a microcontroller that is disposed inside the outer peripheral portion in plan view and that is configured to control the touch sensor; a connector that is disposed on the main board at a position closer to the outer peripheral portion than the microcontroller in plan view and that is electrically connected to the integrated circuit element; and a connection board on one end side of which is mounted the microcontroller and that has a connection cable on the other end side thereof to which is connected the connector, the connection board extending from the one end side toward the connector in plan view, wherein in plan view, the connection board is disposed separated from an electromagnetic interference object mounted on the main board.

### BRIEF DESCRIPTION OF THE DRAWINGS

FIG. 1 is a perspective view of a projector according to a first embodiment in a front view.

FIG. 2 is a perspective view of the projector according to the first embodiment in a back view.

FIG. 3 is an explanatory diagram illustrating an optical configuration of the projector according to the first embodiment.

FIG. 4 is a perspective view illustrating a state in which a projector main body according to the first embodiment is rotated.

FIG. 5 is a perspective view illustrating a lower portion of the projector according to the first embodiment.

FIG. 6 is a top view illustrating a first surface of a housing with a cover removed.

FIG. 7 is a cross-sectional view taken along line VII-VII in FIG. 6.

FIG. 8 is a diagram illustrating the projector main body from which the housing and the cover are removed.

FIG. 9 is a plan view of a main board as viewed from above in an opposing direction.

FIG. 10 is a perspective view illustrating the auxiliary board.

FIG. 11 is a block diagram illustrating a configuration of boards.

FIG. 12 is a diagram illustrating a projector main body of a projector according to a second embodiment.

### DESCRIPTION OF EMBODIMENTS

### First Embodiment of Projector

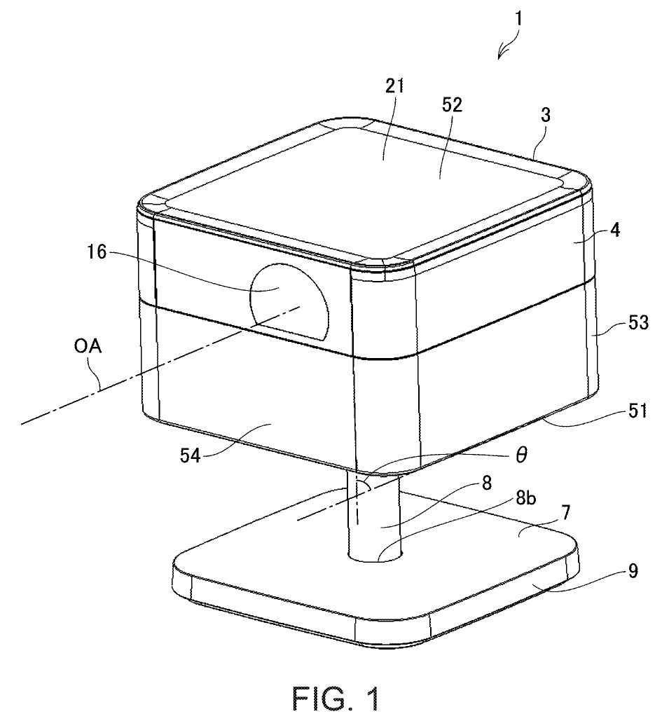

A projector according to a first embodiment will be described below with reference to FIG. 1 to FIG. 11.

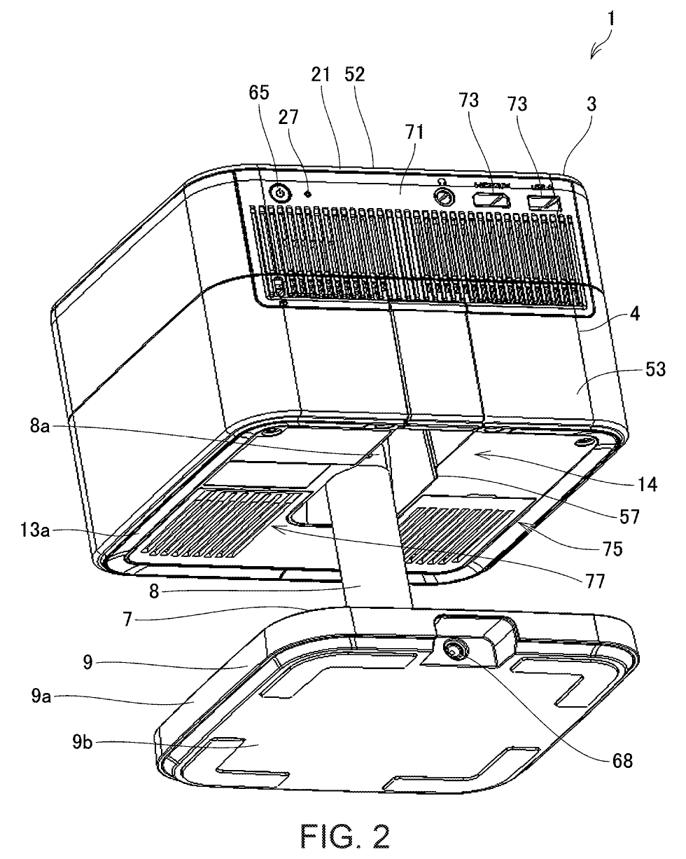

FIG. 1 is a perspective view of the projector 1 in a front view. FIG. 2 is a perspective view of the projector 1 in a back view.

### Projector Main Body

A projector 1 is for home use, for example, and is used by being placed on a side table of a bed in a bedroom, for example.

The projector 1 includes a projector main body 3 having a rectangular box shape and a leg section 7 that supports the projector main body 3. The projector main body 3 includes a housing 4 having a substantially rectangular parallelepiped shape and a cover 21 that covers a first surface 52 of the housing 4. The top surface section of the projector main body 3 has a double structure formed of the first surface 52 of the housing 4 and the cover 21.

As illustrated in FIG. 1, a projection lens 16 for projecting image light is provided on a front surface 54 of the projector main body 3. FIG. 1 illustrates an optical axis OA of the image light projected by the projection lens 16 onto the projection surface. The optical axis OA is a central axis of a projection image, and is, for example, a virtual axis passing through the optical center of the projection lens 16. In FIG. 1, an image projected by the projector main body 3 is projected forward, and the optical axis OA is parallel to an installation surface of the projector 1.

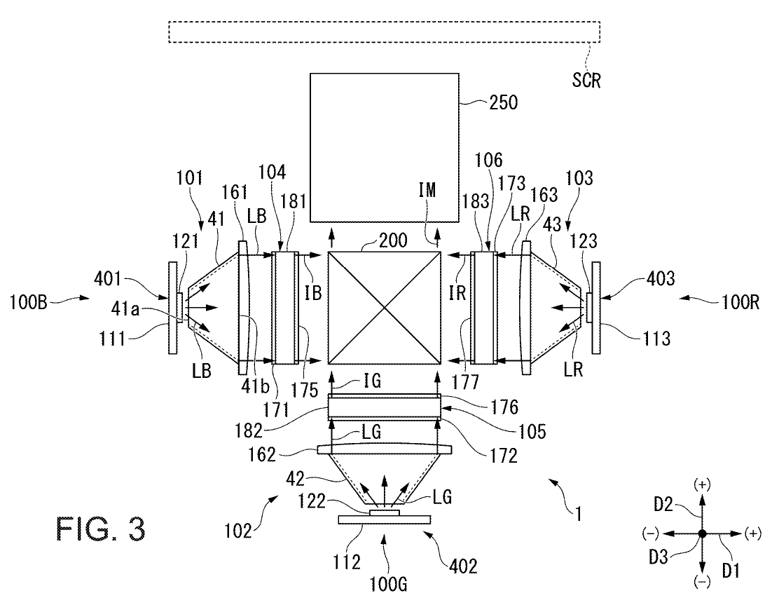

FIG. 3 is an explanatory diagram illustrating an optical configuration of the projector main body 3. The optical configuration is accommodated in the projector main body 3.

The projector main body 3 includes a first image forming module 100B, a second image forming module 100G, a third image forming module 100R, a light combining element 200, and a projection optical system 250, as illustrated in FIG. 3.

The first image forming module 100B includes a blue light emitting section 101 and a blue light modulation device 104. The second image forming module 100G includes a green light emitting section 102 and a green light modulation device 105. The third image forming module 100R includes a red light emitting section 103 and a red light modulation device 106.

First, the first image forming module 100B will be described. The blue light emitting section 101 of the first image forming module 100B emits blue light LB. In the following description, a direction parallel to an optical axis of the blue light LB emitted from the blue light emitting section 101 is defined as a D1 direction. Assuming that one side in the D1 direction is a -D1 side, and the opposite side to the -D1 side in the D1 direction is defined as a +D1 side. A direction orthogonal to the D1 direction in a plane including the optical axis of the blue light LB is defined as a D2 direction. Assuming that one side in the D2 direction is a -D2 side, and the opposite side to the -D2 side in the D2 direction is defined as a +D2 side. A direction orthogonal to the D1 direction and the D2 direction is defined as D3 direction. The blue light LB emitted from the blue light emitting section 101 travels toward the +D1 side along the D1 direction.

The blue light emitting section 101 has a first light source 401, a first light guide element 41, and a first parallelizing element 161. A first light emitter 121 of the first light source 401 is supported by a first board 111. The first board 111 is a plate including a plane parallel to the D2 direction and the D3 direction.

The first light emitter 121 is provided on a plate surface of the first board 111 on the +D1 side. A light emitting surface of the first light emitter 121 is a surface on the +D1 side, which is the opposite side than the surface provided on the first board 111. The first light emitter 121 emits the blue light LB in a blue wavelength band in the visible wavelength band. The blue wavelength band corresponds to a first wavelength band. The blue light LB corresponds to first light. The blue light LB is emitted toward the +D1 side around the axis passing through the centers of the light emitting surface of the first light emitter 121 and parallel to the D1 direction. The blue wavelength band is, for example, a wavelength band from 420nm to 500nm. The blue wavelength band has the shortest wavelength among the color lights used in the three plate projector, and thus, has high energy.

The first light emitter 121 is formed of, for example, an LED that emits the blue light LB. Note that the first light emitter 121 may be constituted by one LED or may be constituted by all of a plurality of LEDs. In the case where the first light emitter 121 is configured by a plurality of LEDs, the LEDs are arranged in a region occupied by the first light emitter 121 in a plane including the D2 direction and the D3 direction.

The first light guide element 41 is provided in the optical path of the blue light LB emitted from the first light source 401 and is disposed in a position that is on the +D1 side from the first light emitter 121 of the first light source 401 and that overlaps the first light emitter 121 in the D2 direction and the D3 direction. The first light guide element 41 restricts the light guide path for guiding the blue light LB emitted from the first light emitter 121 and causes the blue light LB to propagate toward a first light modulation element 181.

The first parallelizing element 161 is provided on the optical path of the blue light LB emitted from the first light guide element 41. The first parallelizing element 161 parallelizes the blue light LB emitted from the first light guide element 41 along the D1 direction.

The blue light modulation device 104 has a first incident side polarization element 171, the first light modulation element 181, and a first emission side polarization element 175. The blue light modulation device 104 is provided on the optical path of the blue light LB emitted from the first parallelizing element 161.

The first incident side polarization element 171 is disposed on the +D1 side of the first parallelizing element 161. The first incident side polarization element 171 emits predetermined polarized light of the blue light LB emitted from the first parallelizing element 161 toward the +D1 side along the D1 direction. The first incident side polarization element 171 is, for example, a reflective polarizing plate or an absorptive polarizing plate.

The first light modulation element 181 is disposed on the +D1 side of the first incident side polarization element 171. The first light modulation element 181 modulates the blue light LB emitted from the first incident side polarization element 171. The first light modulation element 181 is, for example, a transmissive liquid crystal panel. The liquid crystal panel constituting the first light modulation element 181 modulates light based on blue image information to generate blue image light IB. The first light modulation element 181 emits the generated image light IB toward the +D1 side along the D1 direction.

The first emission side polarization element 175 is disposed on the +D1 side of the first light modulation element 181. The first emission side polarization element 175 emits predetermined polarized light of the image light IB emitted from the first light modulation element 181 toward the +D1 side along the D1 direction. The first emission side polarization element 175 is, for example, a reflective polarizing plate or an absorptive polarizing plate.

Next, the second image forming module 100G will be described. The green light emitting section 102 of the second image forming module 100G is disposed on the +D1 side and the -D2 side from the blue light emitting section 101, and is disposed in a region overlapping the blue light emitting section 101 in the D3 direction. The green light emitting section 102 emits green light LG. The green light LG emitted from the green light emitting section 102 travels toward the +D2 side along the D2 direction.

The green light emitting section 102 has a second light source 402, a second light guide element 42, and a second parallelizing element 162. A second light emitter 122 of the second light source 402 is supported by a second board 112. The second board 112 is a plate including a plane parallel to the D2 direction and the D3 direction.

The second light emitter 122 is provided on a plate surface of the second board 112 on the +D1 side. A light emitting surface of the second light emitter 122 is a surface on the +D1 side, which is the opposite side from the surface provided on the second board 112. The second light emitter 122 emits green light LG in a green wavelength band in the visible wavelength band. The green wavelength band corresponds to a second wavelength band. The green light LG corresponds to second light. The green light LG is emitted toward the +D2 side around the axis passing through the centers of the light emitting surface of the second light emitter 122 and parallel to the D2 direction. The green wavelength band is, for example, a wavelength band from 500nm to 600nm. Since the green wavelength band is easily recognized by the human eye, a large amount of light is required when the green wavelength band is projected on a screen SCR. Similarly to the first light emitter 121, the second light emitter 122 is formed of, for example, an LED that emits the green light LG.

The second light guide element 42 is provided on the optical path of the green light LG emitted from the second light source 402. The second light guide element 42 restricts the light guide path for guiding the green light LG emitted from the second light emitter 122 and causes the green light LG to propagate to a second light modulation element 182.

The second parallelizing element 162 parallelizes the green light LG emitted from the second light guide element 42 along the D2 direction, as with the first parallelizing element 161.

The green light modulation device 105 has a second incident side polarization element 172, the second light modulation element 182, and a second emission side polarization element 176. The green light modulation device 105 is provided on the optical path of the green light LG emitted from the second parallelizing element 162.

The second incident side polarization element 172 emits predetermined polarized light out of the green light LG emitted from the second parallelizing element 162 toward the +D2 side along the D2 direction, similarly to the first incident side polarization element 171.

The second light modulation element 182 modulates the green light LG emitted from the second incident side polarization element 172, similarly to the first light modulation element 181. The second light modulation element 182 generates green image light IG based on green image information. The second light modulation element 182 emits the image light IG toward the +D2 side along the D2 direction.

The second emission side polarization element 176 emits predetermined polarized light out of the image light IG emitted from the second light modulation element 182 toward the +D2 side along the D2 direction, similarly to the first emission side polarization element 175.

Next, the third image forming module 100R will be described. The red light emitting section 103 of the third image forming module 100R is disposed on the +D1 side from the green light emitting section 102, and is disposed in a region overlapping the blue light emitting section 101 in the D2 direction and the D3 direction. The red light emitting section 103 emits red light LR. The red light LR emitted from the red light emitting section 103 travels toward the -D1 side along the D1 direction.

The red light emitting section 103 has a fourth light source 403, a third light guide element 43, and a third parallelizing element 163. A third light emitter 123 of the fourth light source 403 is supported by a third board 113. The third board 113 is a plate including a plane parallel to the D2 direction and the D3 direction.

The third light emitter 123 is provided on a plate surface of the third board 113 on the +D1 side. A light emitting surface of the third light emitter 123 is a surface on the +D1 side, which is the opposite side from the surface provided on the third board 113. The third light emitter 123 emits red light LR in a red wavelength band in the visible wavelength band. The red wavelength band corresponds to a third wavelength band. The red light LR corresponds to third light. The red light LR is emitted toward the -D1 side around the axis passing through the centers of the light emitting surface of the third light emitter 123 and parallel to the D1 direction. The red wavelength band is, for example, a wavelength band from 610nm to 700nm. The third light emitter 123 is formed of, for example, an LED that emits red light LR, similarly to the first light emitter 121 and the second light emitter 122.

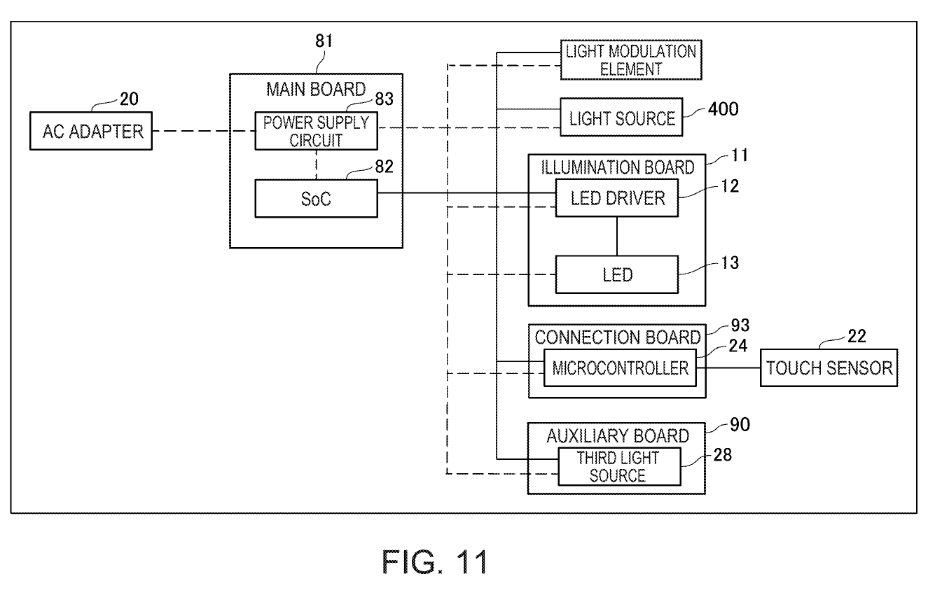

The third light guide element 43 is provided on the optical path of the red light LR emitted from the fourth light source 403. The third light guide element 43 restricts the light guide path for guiding the red light LR emitted from the third light emitter 123 and causes the red light LR to propagate to a third light modulation element 183. The first light source 401, the second light source 402, and the fourth light source 403 constitute a light source 400 (see FIG. 11).

The third parallelizing element 163 parallelizes the red light LR emitted from the third light guide element 43 along the D1 direction, similarly to the first parallelizing element 161 and the second parallelizing element 162.

The red light modulation device 106 has a third incident side polarization element 173, the third light modulation element 183, and a third emission side polarization element 177. The red light modulation device 106 is provided on the optical path of the red light LR emitted from the third parallelizing element 163.

The third incident side polarization element 173 emits predetermined polarized light out of the red light LR emitted from the third parallelizing element 163 toward the -D1 side along the D1 direction, similarly to the first incident side polarization element 171 and second incident side polarization element 172.

The third light modulation element 183 modulates the red light LR emitted from the third incident side polarization element 173, similarly to the first light modulation element 181 and the second light modulation element 182. The third light modulation element 183 generates red image light IR. The third light modulation element 183 emits the image light IR toward the -D1 side along the D1 direction.

The third emission side polarization element 177 emits predetermined polarized light out of the image light IR emitted from the third light modulation element 183 toward the -D1 side along the D1 direction, similarly to the first emission side polarization element 175 and the second emission side polarization element 176.

The light combining element 200 is disposed in a region where the optical path of the blue image light IB, the optical path of the green image light IG, and the optical path of the red image light IR intersect with each other. The light combining element 200 combines the image light IB, IG, and IR emitted from the first emission side polarization element 175, the second emission side polarization element 176, and the third emission side polarization element 177 with one another and emits image light IM thus generated toward the +D2 side along the D2 direction.

The projection optical system 250 is disposed in the optical path of the image light IM emitted from the light combining element 200. The projection optical system 250 projects the image on the screen SCR, and enlarges and displays the image input to the first light modulation element 181, the second light modulation element 182, and the third light modulation element 183 on the screen SCR.

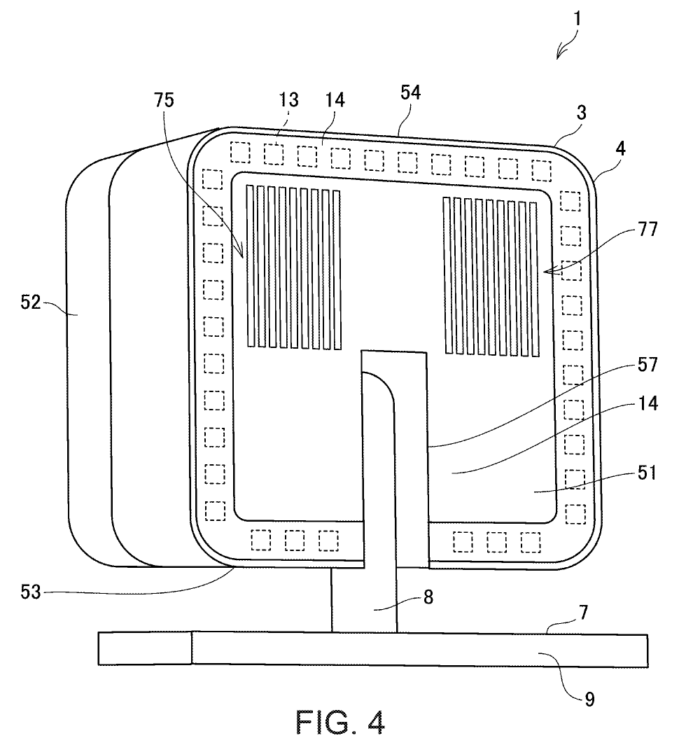

FIG. 4 is a perspective view illustrated a state in which the projector main body 3 is rotated.

The projector main body 3 includes a swing mechanism that rotates the projector main body 3 relative to the leg section 7.

The projector main body 3 is displaceable from the state illustrated in FIG. 2 to the state illustrated in FIG. 4 by the swing mechanism (not shown). The position of the displacement of the projector main body 3 by the swing mechanism is desirably two or more positions, and it may be smoothly displaced or may be displaced in a plurality of stages. The displacement may be realized by any one of horizontal rotation, vertical rotation, and three dimensional rotation. The swing mechanism is an example of a "rotation mechanism".

As illustrated in FIG. 2 and FIG. 4, the leg section 7 includes a substantially rectangular shape base 9 and a cylindrical shape support pipe 8 extending upward from the center of the base 9.

A first end section 8a of the support pipe 8 is connected to the projector main body 3, and a second end section 8b is connected to the base 9.

The first end section 8a along an lengthwise axis of the support pipe 8 is inserted into a notch 14, which has an lengthwise axis 57 and which is opened in a bottom surface 51 of the projector main body 3, and is coupled to the bottom surface 51 side of the projector main body 3 via the swing mechanism. A surface where the notch 14 is present is one surface from which the illumination light from a plurality of LEDs 13 is emitted. The "one surface" of the projector main body 3 is the bottom surface 51 of the projector main body 3.

The projector main body 3 is swung in the direction along the lengthwise axis 57 of the notch 14 by the swing mechanism.

The number of the support pipes 8 is not limited to one, and may be two or three. The support pipe 8 may be bent or branched in the middle. The cross section of the support pipe 8 may have various shapes such as a circular shape and a rectangular shape, and the leg section 7 may have, for example, a plate shape.

The shape of the base 9 is not particularly limited, and may be various shapes such as a disc shape. The leg section 7 may be configured only by the support pipe 8 without including the base 9.

### Illumination System

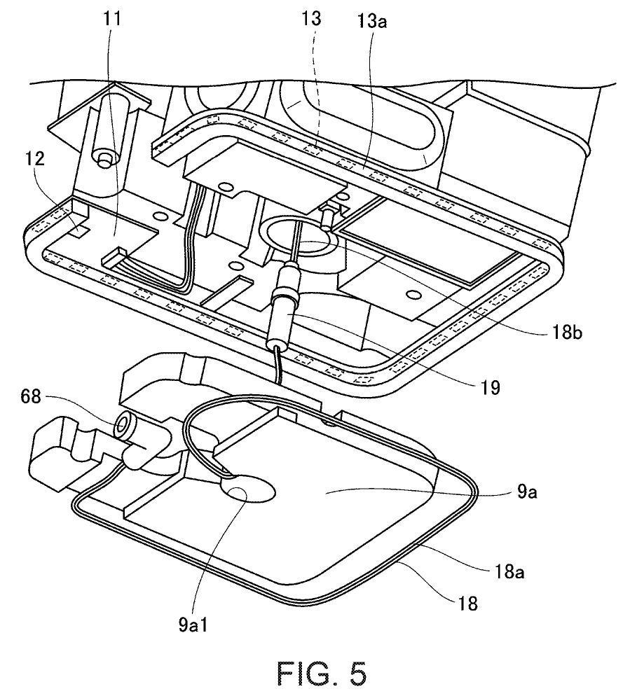

FIG. 5 is a perspective view illustrating a lower portion of the projector 1, and is a diagram in which the housing 4, the cover 21, and a part of the leg section 7 of the projector 1 are omitted.

As shown in FIG. 5, a substantially C-shaped illumination board 11 is disposed on the bottom surface 51 of the housing 4 so as to surround the leg section 7.

As shown in FIGS. 2 and 4, the illumination board 11 is disposed along the contour of the bottom surface 51. The plurality of LEDs 13 are mounted on the illumination board 11. The plurality of LEDs 13 are covered by an LED cover 13a made of a box-shaped transparent member. The illumination board 11 is provided with an LED driver 12. The plurality of LEDs 13 are controlled by the LED driver 12. The LED driver 12 is an example of a "driver element". Each of the plurality of LEDs 13 is an example of a "second light source." The light from the plurality of LEDs 13 may softly illuminate the periphery of the side table, like a lamp placed on the side table of the bed. Since the projector 1 also functions as an ambient light in this way, the convenience and the effect of the presentation can be improved.

The plurality of LEDs 13 are arranged along the contour of the bottom surface 51, but is interrupted by the opening of the notch 14 formed in the bottom surface 51, so that they are arranged in a substantially C-shape. The shape is not limited to the substantially C-shape, and although not illustrated in the drawings, the plurality of LEDs 13 may extend continuously along the entire periphery of an edge section of the notch 14 and be arranged in a ring shape. Note that it is desirable that at least two of the LEDs 13 among the LEDs 13 are arranged along the contour of the bottom surface 51, and some of the LEDs 13 may be included that are not arranged along the contour. The LEDs 13 may be disposed on the outer peripheral portion of the support pipe 8, or may be disposed on both the bottom surface 51 and the support pipe 8.

The illumination light from the plurality of LEDs 13 are emitted from an emission surface of the bottom surface 51 of the housing 4. The emission surface may be formed at a position recessed from the bottom surface 51, may be formed to be flush with the bottom surface 51, or may protrude from the bottom surface 51 to be formed in a convex shape.

For example, when the emission surface is formed at a recessed position, the plurality of LEDs 13 are not exposed from the bottom surface 51, and thus, the LEDs 13 are protected.

The emission surface in the present embodiment refers to a surface of the LED cover 13a from which light from the LED 13 is emitted.

The emission surface may be flush with the bottom surface 51 or may protrude from the bottom surface 51. When it is disposed flush with the bottom surface 51 of the housing 4, the aesthetic appearance is improved, and damage to the LED 13 is suppressed. In a case where the light source is projected from the bottom surface 51, it is possible to softly illuminate the periphery of the side table more effectively. The plurality of LEDs 13 may be configured to change brightness according to use environments.

The plurality of LEDs 13 are arranged at equal intervals. The distances between two adjacent LEDs 13 among the plurality of LEDs 13 are equal to or larger than the 5 mm and equal to or less than the 30 mm. The distance is a distance in a plan view, and is a distance between the centers of two adjacent LEDs 13. If the distance is less than the 5 mm, there is a risk of thermal influence between the LED 13, and the difficulty of mounting the LED 13 increases. When the distance exceeds the 30 mm, the expressiveness of the presentation of the LED 13 is reduced, and the shadow between the adjacent LEDs 13 becomes more noticeable.

The number of the plurality of LEDs 13 to be mounted is 10 pieces or more and 100 pieces or less, and desirably 20 pieces or more and 50 pieces or less. If there are fewer than 24 pieces, the effect is felt as a lonely impression. When the number of mounted is 24 pieces, the distance is 24 mm.

The number of mounts in LEDs 13 is 36 pieces, and the mounting distance is 16 mm. However, a single LED 13 may be added between the LEDs 13. In this case, the mounting distance of the LEDs 13 is 8 mm. If two are added, the mounting distance will be 5 mm. In this case, the difficulty of mounting is slightly increased, and the arrangement is difficult.

The plurality of LEDs 13 may include the first light emitter that emit light of a first color and the second light emitter that emit light of a second color different from the first color.

The first light emitter is a light emitting diode element that emits light of the first color, and the second light emitter is a light emitting diode element that emits light of the second color.

That is, since each of the "second light sources" includes a light emitting diode element, the degree of freedom of the color and the arrangement of the elements is increased, the degree of freedom of the design can be increased, and the effect of the presentation and the convenience are improved.

The light from the plurality of LEDs 13 may include a plurality of colors. For example, the color may be changed or the light may be blinked according to the state, the setting, or the like at the time of activation of the projector 1. Since the LED 13 is positioned on the bottom surface 51, it serves as indirect ambient light that softly illuminates the entire space, and does not cause glare when projecting with the projector 1.

The LED 13 may be an LED chip or an organic EL panel. The plurality of second light sources may emit light to the outside, and the second light sources may be attached at any position.

For example, the second light source may be provided in the projector main body 3 or may be attached to the surface of the projector main body 3.

### Image and Direction of Illumination Light

The projector main body 3 includes the bottom surface 51 through which illumination light from the plurality of LEDs 13 is emitted, and the front surface 54 through which image light from the projection lens 16 is emitted, as illustrated in FIG. 1.

The image light and the illumination light are emitted from different surfaces of the projector main body 3. In the present embodiment, the image light is emitted from the front surface, and the illumination light is emitted from the bottom surface. An angle θ formed by the front surface 54 and the bottom surface 51 is 90°. That is, the angle θ formed by the direction in which the image light from the projector main body 3 is emitted and the direction in which the illumination light from the plurality of LEDs 13 is emitted is 90°. Therefore, it is possible to prevent the projected image from becoming difficult to see due to the illumination light.

In the above description, the projector main body 3 has a rectangular box shape, but in the case where the projector main body 3 has a cylindrical shape, although not shown, the projection lens 16 can be disposed on the front surface side of the projector main body 3, and a plurality of LEDs 13 can be arranged on the back surface side.

In this case, it is desirable that an angle θ formed by the direction in which the image light is emitted and the direction in which the illumination light is emitted is 90° or more.

Here, the direction in which the image light is emitted refers to a direction in which the light travels along the optical axis of the image light.

The direction in which the illumination light is emitted refers to either the direction in which the light travels along the central axis of the entire light, when the entire plurality of LEDs 13 is considered as one illumination light, or the direction in which the light travels along the optical axis of each LED 13.

### Touch Sensor

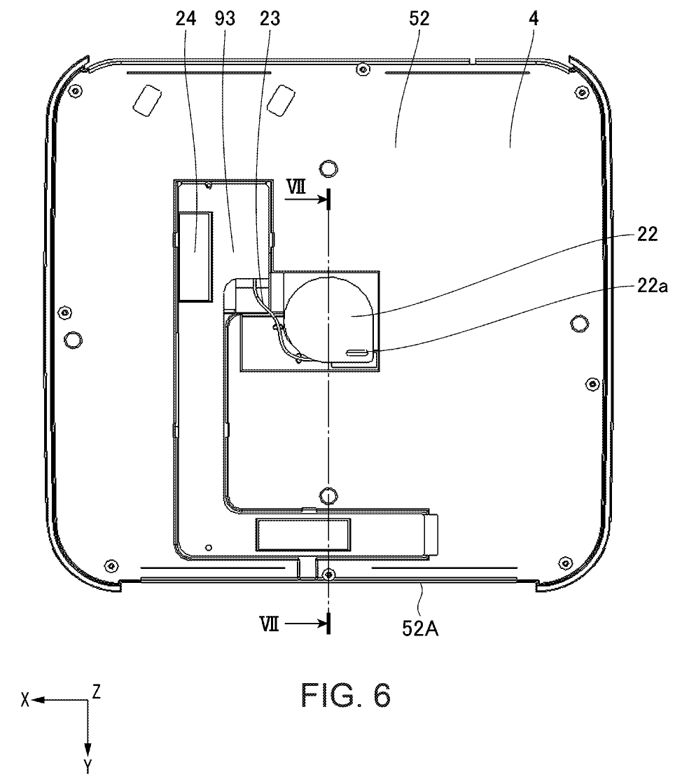

FIG. 6 is a top view illustrating the first surface 52 of the housing 4 with the cover 21 removed.

As shown in FIG. 1, the housing 4 includes the first surface 52. The first surface 52 is opposing the bottom surface 51 from which the illumination light of the LED 13 is emitted. As illustrated in FIG. 6A, a touch sensor (sensor) 22, which detects the user's contact with the projector main body 3, is disposed between the first surface 52 and the cover 21.

The touch sensor 22 may be a button or a sensor. The cover 21 is provided on the touch sensor 22, and as illustrated in FIG. 6, the touch sensor 22 is disposed on a back surface of the cover 21. Since the touch sensor 22 is hidden by the cover 21, the appearance of the projector 1 can be improved. The touch sensor 22 is an example of a "sensor". Note that when the position of the projector main body 3 is displaced by the swing mechanism, it is desirable that the touch sensor 22 is not disposed on the same surface as the leg section 7.

In the present embodiment, the touch sensor 22 is a copper foil tape. A sensor wiring 23 is attached to an end portion of the touch sensor 22 by soldering. The sensor wiring 23 is connected to a microcontroller 24. An oval shaped opening 22a is formed near a joint section of the touch sensor 22 with the sensor wiring 23. By this, the excessive solder is removed from the opening 22a at the time of soldering. Therefore, the solder does not contaminate the touch sensor 22. By this, prevents the solder from affecting the touch sensor 22, thereby preventing a decrease in sensitivity. The solder is an example of a "conductive bonding material".

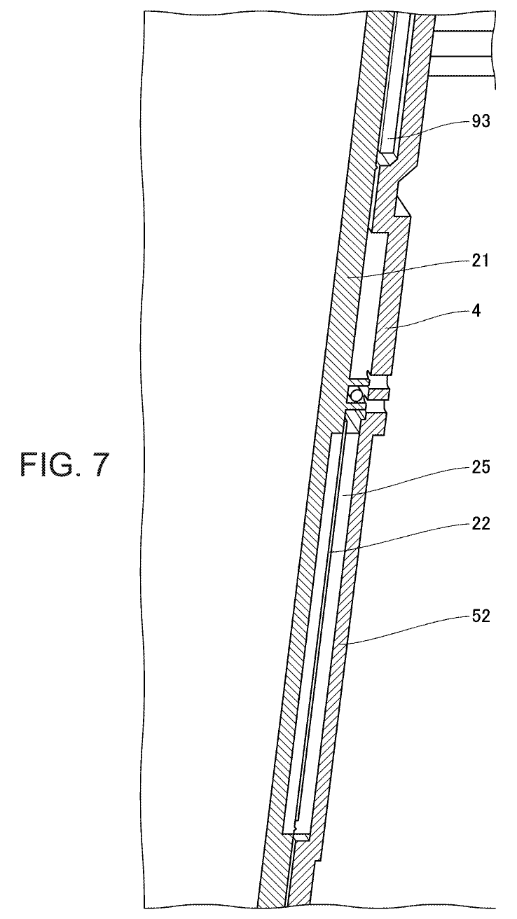

FIG. 7 is a cross-sectional view taken along line VII-VII in FIG. 6.

A spacer 25 is disposed below the touch sensor 22 and, in a state where the cover 21 is attached to the first surface 52, the touch sensor 22 and the spacer 25 are sandwiched between the first surface 52 and the cover 21 as illustrated in FIG. 7. The touch sensor 22 is in a state of being pressed against the back surface of the cover 21 by the spacer 25. Therefore, air is less likely to enter between the touch sensor 22 and the cover 21, and it is possible to prevent the sensitivity of the touch sensor 22 from being lowered by air.

Since the touch sensor 22 is hidden by the cover 21, the aesthetic appearance of the projector 1 is improved. Since the touch sensor 22 is used, the ambient light can be turned on and off without using a remote controller for the ambient light.

When the touch sensor 22 is repeatedly tapped, the ambient light may be turned on and off, the brightness may be decreased, the color of the ambient light may be changed, or the like.

A control section that controls the plurality of LEDs 13 is not limited to the touch sensor 22. For example, another switch, a button, a touch panel, or the like may be used. The control section for turning on the plurality of LEDs 13 is desirably a sensor or the like that is attached to the projector main body 3 and that can be operated by touching the projector main body 3 manually.

As illustrated in FIG. 2, a power button 65 is disposed on a back surface 53 of the projector main body 3. The power button 65 is a button for switching the operation of the projector main body 3 between on and off.

As illustrated in FIG. 2, an indicator 27 that emits light to the outside of the projector main body 3 is disposed on the back surface 53 of the projector main body 3. The indicator 27 is an LED indicator using a third light source 28 (see FIG. 11) different from the LED 13, and notifies the state of the optical configuration of the projector main body 3.

Since the indicator 27 is positioned on the opposite side than the projection lens 16, there is an advantage that the user does not need to directly look at the projection light when viewing the indicator 27.

An air outlet port 71, an air outlet fan (not illustrated), and an opening 73 for a video terminal are disposed on the back surface 53 of the projector main body 3. A first air intake port 75 and a second air intake port 77 are disposed side by side on the left and right sides on the bottom surface 51 of the projector main body 3. The side surfaces of the projector main body 3 include the back surface 53 and the front surface 54 other than the bottom surface 51 and the first surface 52. By driving the air outlet fan, air is sucked into the projector 1 through the air intake ports 75 and 77. The air thus sucked cools the heat generating devices inside the projector 1 and is then discharged through the air outlet port 71.

The position of the air outlet port 71 is not limited to the back surface 53, and may be the bottom surface 51, the first surface 52, or the side surface of the projector main body 3. Note that it is desirable that the air outlet port 71 and the air intake ports 75 and 77 are not disposed on the same surface so as not to suck in the discharged air again.

It is desirable that the air outlet port 71 and the air intake ports 75 and 77 are not disposed on the same surface as the touch sensor 22. By this, the dust guided along the flow of air can be suppressed from adhering to the touch sensor 22.

The opening 73 for the video terminal illustrated in FIG. 2 is an insertion port of a connection terminal for supplying a video from an external device to the projector main body 3. In the present embodiment, the opening 73 for the video terminal is an opening for a Universal Serial Bus (USB) terminal and a High-Definition Multimedia Interface (registered trademark: HDMI) terminal. Therefore, by connecting the external device and the projector main body 3 to each other via the USB terminal or the HDMI (registered trademark) terminal, the projector main body 3 can project video information from the external device as image light. Note that it is desirable that the opening 73 for the video terminal is not disposed on the same surface as the touch sensor 22.

### Wiring System of Board

As illustrated in FIG. 2, the base 9 has a base case 9a with an open lower surface, and a base cover 9b that covers the lower surface of the base case 9a.

As illustrated in FIG. 5, a round hole 9a1 penetrating in the vertical direction is formed in the base case 9a. The second end section 8b of the support pipe 8 is supported by the round hole 9a1.

As illustrated in FIG. 2, the base 9 includes an AC adapter terminal 68 connected to a power supply. The AC adapter terminal 68 is disposed on the side surface of the base case 9a. An AC adapter 20 (see FIG. 11) is connected to the AC adapter terminal 68. The AC adapter terminal 68 is an example of a "power supply terminal". The AC adapter 20 is an example of a "power supply adapter".

Since the AC adapter terminal 68 is disposed not on the projector main body 3 but on the base 9, a power supply wiring 18 connected to the AC adapter terminal 68 does not interfere with the swinging of the projector main body 3.

As illustrated in FIG. 5, the power supply wiring 18 extends from the AC adapter terminal 68. The power supply wiring 18 is disposed along the outer periphery on the lower surface of the base case 9a, passes through the inside of the support pipe 8 from the round hole 9a1, and is connected to a power supply circuit 83 (see FIG. 11) of a main board 81 (to be described later). In this manner, the power supply wiring 18 is provided with play, and thereby, workability at the time of assembly is facilitated, and damage to the power supply wiring 18 when the projector main body 3 is rotated is suppressed.

The power supply wiring 18 is configured by a first wiring 18a extending from the AC adapter terminal 68 and a second wiring 18b extending from the main board 81. The first wiring 18a and the second wiring 18b are connected by a connector 19 in the support pipe 8. Since the connector 19 is not accommodated inside the projector main body 3, the workability at the time of assembly or the like is improved.

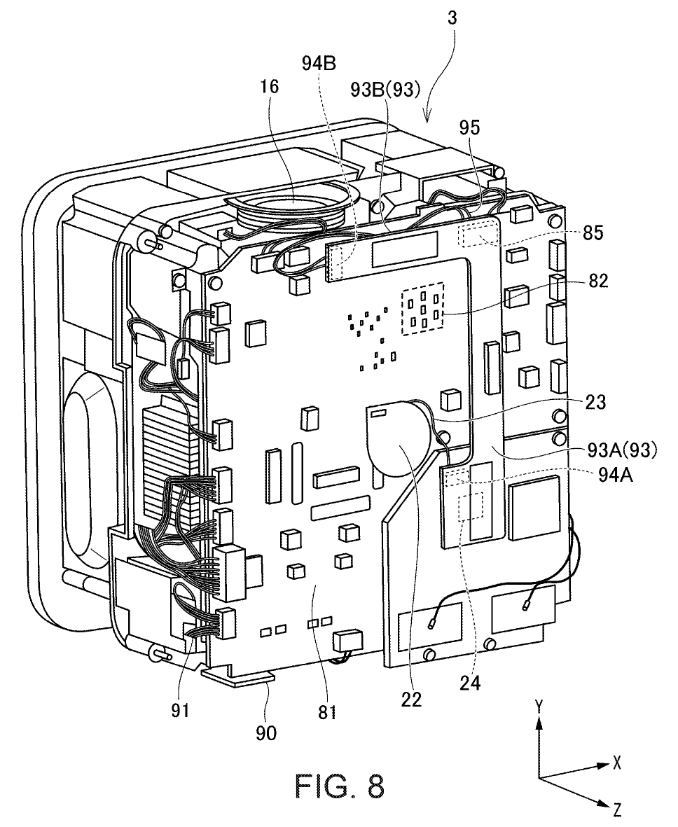

FIG. 8 is a diagram illustrating the projector main body 3 from which the housing 4 and the cover 21 are removed. The projector main body 3 includes the main board 81, a connection board 93, and an auxiliary board 90. The main board 81 of the projector 1 is disposed below the housing 4 and on the first surface 52 of the projector main body 3.

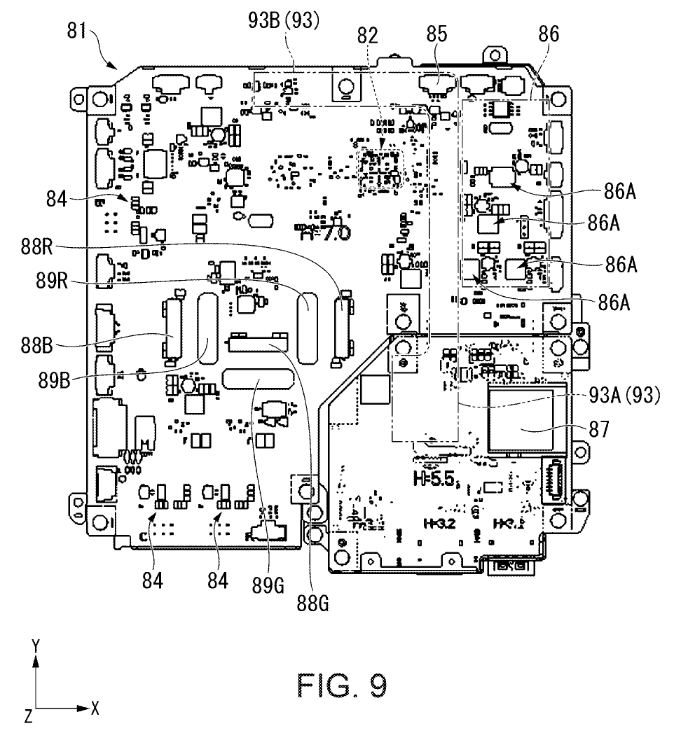

FIG. 9 is a plan view of the main board 81 as viewed from above in the opposing direction that opposes the main board 81. As illustrated in FIGS. 8 and 9 the main board 81 is formed in a substantially rectangular shape. The main board 81 has a System on a Chip (SoC) 82, a driver element 84 that controls the light source 400, a connector 85, a DC/DC circuit 86 that has a plurality of coils 86A and that supplies power to the SoC 82, and a communication module 87. The SoC 82 corresponds to an example of an “integrated circuit element". That is, the SoC 82, the driver element 84, the connector 85, the DC/DC circuit 86, and the communication module 87 are mounted (installed, placed) on the main board 81.

The SoC 82, the driver element 84, the DC/DC circuit 86, and the communication module 87 are examples of electromagnetic interference objects that have a large deterioration in EMI characteristics.

The connector 85 is electrically connected to the SoC 82. The connector 85 is disposed on an outer peripheral portion of the upper surface of the main board 81. The connector 85 is disposed at a position closer to the outer peripheral portion than the touch sensor 22 disposed inside the outer peripheral portion of the main board 81 in plan view (hereinafter simply referred to as "plan view") of the projector main body 3 viewed from above.

Assuming that the vertical direction of the projector main body 3 is a Z direction, a direction in which an outer peripheral portion of the main board 81 on which the connector 85 is disposed extends in plan view is an X direction, and a direction perpendicular to both the Z direction and the X direction is a Y direction. The +Z side is the upper side, and the -Z side is the lower side. The Z direction corresponds to a opposing direction opposing the main board 81. The connector 85 is disposed between the SoC 82 and the DC/DC circuit 86 in the X direction.

The connection board 93 is formed of, for example, a non-flexible hard material (rigid board). Examples of the hard material include a board obtained by impregnating paper with a phenol resin, a board obtained by impregnating paper with an epoxy resin, a glass composite board, and a glass epoxy board.

As illustrated in FIG. 7, the connection board 93 is disposed between the first surface 52 of the housing 4 and the cover 21. The connection board 93 is a board on which the microcontroller 24 that controls the touch sensor 22 is disposed on the -Z side surface. The connection board 93 is separated from the main board 81 in order to reduce the footprint, and is disposed between the housing 4 and the cover 21 where a space can be secured.

The connection board 93 includes a first portion 93A and a second portion 93B. The first portion 93A extends in the Y-direction. The position of the first portion 93A in the X direction is a position overlapping the connector 85 in plan view. The first portion 93A has a connection connector 94A on a surface opposing the main board 81 on the -Y side, which is one end side. The connection connector 94A is electrically connected to the microcontroller 24. The connection connector 94A is connected to the sensor wiring 23. The microcontroller 24 is electrically connected to the touch sensor 22 via the sensor wiring 23.

The first portion 93A linearly extends from the -Y side to the +Y side toward the connector 85. The first portion 93A is disposed separated from the electromagnetic interference object described above in plan view. The first portion 93A is disposed at a position and with a size so as to not overlap the electromagnetic interference object in plan view. As an example, the first portion 93A is disposed at a position and with a size so as to not overlap the SoC 82 described above, the DC/DC circuit 86, and the communication module 87 in plan view. The first portion 93A may extend in a zigzag shape or a curved shape in a path that circumvents the electromagnetic interference object described above in plan view, in addition to a straight line shape, as long as the first portion 93A does not overlap the electromagnetic interference object in plan view.

Since the connection board 93 is a rigid board, bending is suppressed, and thus, it is possible to suppress deterioration of the EMI characteristics due to contact with the electromagnetic interference object. Since the first portion 93A is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B extends from a tip end of the first portion 93A in a direction separated from the connector 85 along the outer peripheral portion of the main board 81 in plan view. The connector 85 opposes the intersection of the first portion 93A and the second portion 93B in the Z direction. The second portion 93B linearly extends from the tip end of the first portion 93A toward the -X side. The second portion 93B is disposed separated from the electromagnetic interference object described above in plan view. The second portion 93B is disposed at a position and with a size so as not to overlap the electromagnetic interference object in plan view. As an example, the second portion 93B is disposed at a position and with a size so as not to overlap the SoC 82 in plan view. The second portion 93B may extend from the tip end of the first portion 93A in a zigzag shape or curved shape path that circumvents the electromagnetic interference object described above in plan view, in addition to extending linearly, as long as the second portion 93B does not overlap the electromagnetic interference object in plan view.

Since the second portion 93B is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B has a second connector 94B at a tip end on the -X side. The second connector 94B is electrically connected to the microcontroller 24. The second connector 94B is connected to a connection cable 95. The connection cable 95 is drawn out from the second connector 94B to the -X side, is then drawn around to the +X side, and is connected to the connector 85 across the first surface 52 in the Z direction via a notch 52A formed at an end edge of the first surface 52 on the +Y side as illustrated in FIG. 6. Therefore, the microcontroller 24 is electrically connected to the SoC 82 via the connection cable 95 and the connector 85. The SoC 82 inputs a detection result of the touch sensor 22 via the microcontroller 24 and the connection cable 95.

Since the distance between the connection board 93 and the main board 81 in the Z direction is several cm, for example, in a case where the second connector 94B is provided at a tip end of the first portion 93A on the +Y side without providing the second portion 93B in the connection board 93, the distance between the connector 85 and the second connector 94B is short. In this case, considering the lengths of the terminals at both ends of the connection cable 95, the movable range of the connection cable 95 becomes short, and the work of attaching the connection cable 95 to the connector 85 and the second connector 94B becomes difficult.

In the present embodiment, the connection board 93 has the second portion 93B, and the second connector 94B is intentionally provided at a position separated from the connector 85, and thus, the distance between the connector 85 and the second connector 94B and the length of the connection cable 95 are increased, and the movable range of the connection cable 95 is increased, and thus, the work of mounting the connection cable 95 on the connector 85 and the second connector 94B is facilitated.

Since the connection cable 95 is connected to the connector 85 across the first surface 52 in the Z direction via the notch 52A on the +Y side, for example, compared to a case where the connection cable 95 is inserted into a hole section formed inside the end edge of the first surface 52 and connected to the connector 85, the work of connecting the connection cable 95 to the connector 85 from the +Y side is facilitated.

The main board 81 has a first light source connector 88B, a second light source connector 88G, and a third light source connector 88R electrically connected to the first light source 401, the second light source 402, and the fourth light source 403, respectively, and an opening section 89B, an opening section 89G, and an opening section 89R through which light source wirings (not shown) electrically connected to the first light source connector 88B, the second light source connector 88G, and the third light source connector 88R, respectively, are inserted. The connection board 93 is disposed apart from the opening section 89B, the opening section 89G, and the opening section 89R in plan view, and the connection board 93 is disposed separated from the opening section 89B, the opening section 89G, and the opening section 89R in plan view, and thus, it is possible to suppress an adverse effect of static charge due to the light source wiring.

As illustrated in FIG. 8, the auxiliary board 90 on which the third light source 28 is mounted is disposed on the back surface 53 of the projector main body 3 and substantially perpendicular to the main board 81. The auxiliary board 90 is connected to the main board 81 by an auxiliary wiring 91.

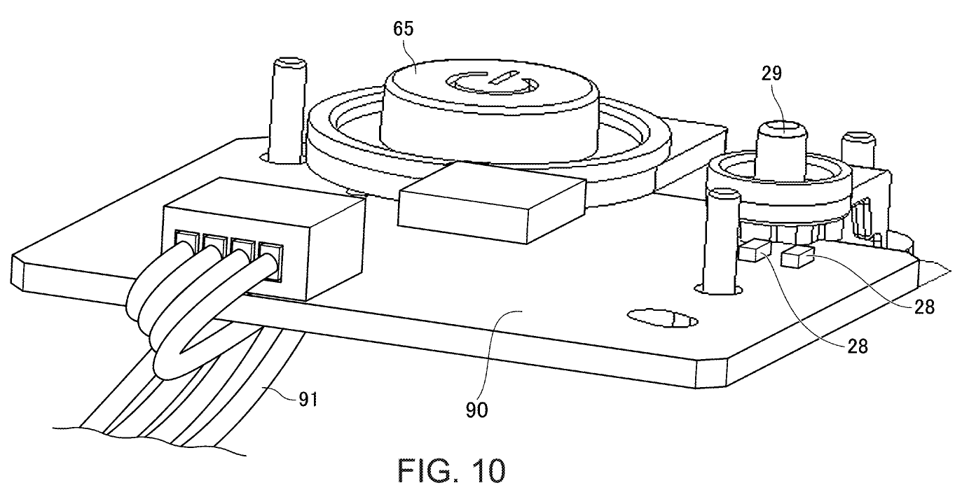

FIG. 10 is a perspective view of the auxiliary board 90.

The power button 65 and the third light source 28 are mounted on the auxiliary board 90. In the present embodiment, the third light source 28 is an LED.

The third light source 28 is disposed so that a lens 29 covers it in the direction of irradiation. A part of the outer end of the lens 29 is exposed to the exterior of the housing 4, and light is emitted to the outside of the projector main body 3 via the lens 29 by the lighting of the third light source 28, and functions as the indicator 27 as illustrated in FIG. 2. In the present embodiment, two third light sources 28 are mounted, and the emission colors thereof are different from each other. The lighting pattern of the third light source 28 allows the user to recognize the state of the projector 1.

In the present embodiment, the microcontroller 24 performs only the detection of the touch sensor 22, receives output information of the touch sensor 22 via the sensor wiring 23 connected to the touch sensor 22, and performs processing according to the output. Since the microcontroller 24 performs only the detection of the touch sensor 22, it is possible to prevent the detection from being missed. The sensor wiring 23 is an example of "wiring for transmitting an output of the touch sensor".

FIG. 11 is a block diagram illustrated a configuration of each of the boards 11, 81, 90, and 93. In FIG. 11, solid line indicates an input/output relationship of a signal, and chain line indicates an electrical connection relationship. The main board 81 is connected to the illumination board 11, the auxiliary board 90, and the connection board 93. The SoC 82 mounted on the main board 81 is connected to the LED driver 12, and controls the LED 13 mounted on the illumination board 11 via the LED driver 12.

As described above, in the projector 1 according to the present embodiment, the connection board 93 is disposed separated from the electromagnetic interference object mounted on the main board 81 in plan view, and therefore, it is possible to suppress deterioration of the EMI characteristics.

The SoC 82 directly controls the third light source 28 mounted on the auxiliary board 90. The third light source 28 is controlled by pulse width modulation control. Since the SoC 82 directly controls the third light source 28 without interposing a driver or the like, the number of components can be reduced.

The SoC 82 is connected to the microcontroller 24 of the connection board 93, and indirectly controls the touch sensor 22 via the microcontroller 24.

That is, in the present embodiment, the SoC 82 directly or indirectly controls the LED 13, the third light source 28, and the touch sensor 22. In this way, since the SoC 82 controls a plurality of components such as the indicator 27 and the LED driver 12 together, the number of components can be reduced as compared with a case where circuits are separately provided.

The main board 81 includes the power supply circuit 83. The power supply circuit 83 is supplied with power via the AC adapter 20 and the power supply wiring 18. The power supply circuit 83 supplies electricity from the AC adapter 20 to the SoC 82, the LED 13, the third light sources 28, the LED driver 12, various elements, and the like. Since the power supply circuit 83 is configured to supply electricity to a plurality of supply destinations, the circuit configuration can be simplified and the number of components can be reduced.

In the present embodiment, since the main board 81, the illumination board 11, the auxiliary board 90, and the connection board 93 are provided separately from each other, it is possible to disperse the heat generated in each board and suppress the influence on the projector 1.

### Second Embodiment of Projector

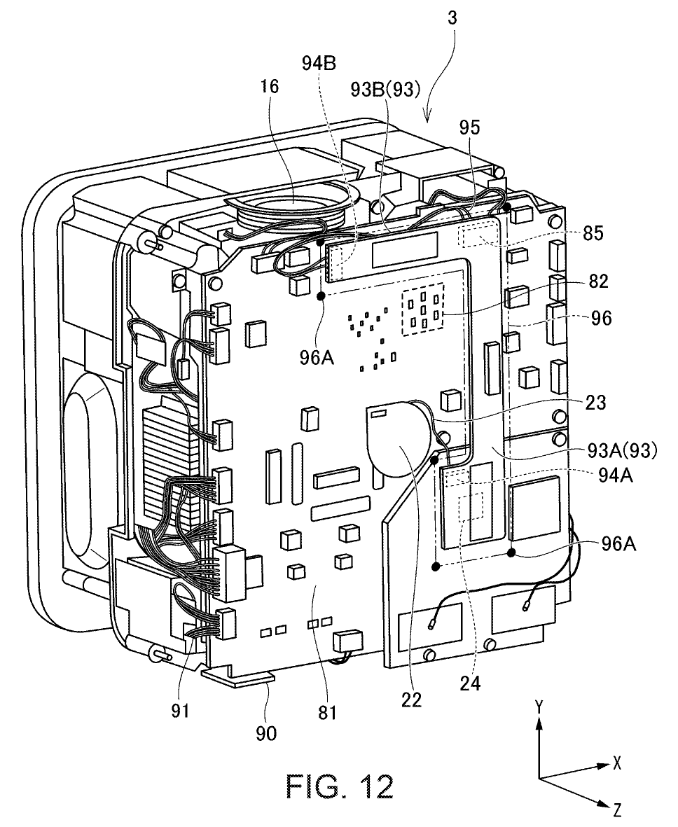

Next, a second embodiment of the projector will be described with reference to FIG. 12.

In this diagram, the same reference symbols are given to the same components as those of the first embodiment illustrated in FIGS. 1 to 11, and the description thereof will be omitted. The second embodiment is different from the first embodiment in the configuration of the connection board 93.

As illustrated in FIG. 12, the connection board 93 of the present embodiment has flexibility, for example. The connection board 93 is, for example, a flexible board in which a conductor foil is provided on a film-like base material. Since the connection board 93 is a flexible board, the thickness and weight of the board can be reduced.

The connection board 93 has a shield layer 96 on a surface thereof. The shield layer 96 is desirably made of a nonmagnetic metal such as aluminum (Al) or copper (Cu) in order to minimize the influence of the magnetic field at the coils 86A of the DC/DC circuit 86. As indicated by black circles in FIG. 12, the shield layer 96 is grounded at a plurality of ground contact sections 96a (six ground contact sections in FIG. 12).

The other configurations are the same as those of the first embodiment.

In the present embodiment, in addition to the same operation and effect as those of the first embodiment, the thickness and weight of the connection board 93 can be reduced.

### Other Embodiments

The above described embodiments are desired embodiments of the present disclosure. However, the present disclosure is not limited to the above described embodiment, and various modifications can be made without departing from the gist of the present disclosure.

For example, in the embodiment described above, the projector main body 3 has the rectangular shaped notch 14 in the bottom view of the projector main body 3. However, the shape of the notch is not particularly limited, and may be an oval shaped notch or a notch having a shape in which a part thereof is widened.

For example, when the number of LEDs as the second light source is small, the SoC may directly perform control without providing the LED driver.

In the embodiment described above, the AC adapter is used as the power supply adapter, and the electricity is supplied to the projector 1 by the AC adapter terminal provided on the base. However, the power supply adapter is not limited to the AC adapter, and an existing power adapter can be used. The power supply terminal can be changed depending on the power supply adapter to be used.

In the above described embodiment, the touch sensor 22 is provided with the oval shaped opening 22a. However, the touch sensor may be provided with a recess instead of the opening. In the case where the recess is provided in the touch sensor, the excess solder flows into the recess, and thus, the solder can be prevented from contaminating the touch sensor and affecting the touch sensor, thereby preventing a decrease in sensitivity.

The bonding between the touch sensor and the sensor wiring is not limited to solder, and an existing conductive bonding material can be used.

In the embodiment described above, a configuration in which the first surface 52 is positioned on the upper side is illustrated, but not limited to this configuration. For example, when the base 9 is disposed on the lower side, the first surface 52 is a top surface positioned on the upper side. On the other hand, for example, in the case in which the base 9 is disposed on the upper side (in the case in which the base 9 is fixed to the ceiling and the projector 1 is suspended), the first surface 52 is a bottom surface positioned on the lower side.

### Summary of Present Disclosure

Hereinafter, a summary of the present disclosure is supplementary noted.

### Supplementary Note 1

A projector includes a light source; a driver element configured to control the light source; an integrated circuit element configured to control the driver element; a main board on which the integrated circuit element is mounted; a sensor disposed inside an outer peripheral portion of the main board in plan view as viewed from an opposing direction that opposes the main board; a microcontroller that is disposed inside the outer peripheral portion in plan view and that is configured to control the touch sensor; a connector that is disposed on the main board at a position closer to the outer peripheral portion than the microcontroller in plan view and that is electrically connected to the integrated circuit element; and a connection board on one end side of which is mounted the microcontroller and that has a connection cable on the other end side thereof to which is connected the connector, the connection board extending from the one end side toward the connector in plan view, wherein in plan view, the connection board is disposed separated from an electromagnetic interference object mounted on the main board.

According to this, the connection board provided in the projector is disposed separated from the electromagnetic interference object, and thus, it is possible to suppress deterioration of the EMI characteristics.

### Supplementary Note 2

The projector according to supplementary note 1, wherein the connection board has a first portion on which the microcontroller is mounted on the one end side and that extends from the one end side toward the connector and a second portion that extends from a tip end of the first portion along the outer peripheral portion in a direction separated from the connector and that has the connection cable at a tip end thereof.

According to this, since the connection cable of the second portion is disposed separated from the connector, the movable range of the connection cable is increased, and thus, it is possible to easily perform the work of mounting the connection cable on the connector.

### Supplementary Note 3

The projector according to supplementary note 1 or supplementary note 2, further including a housing that is configured to house at least the main board and that has a first surface disposed separated from the main board in the opposing direction and a cover configured to cover the first surface, wherein the connection board is disposed between the first surface and the cover.

According to this, it is possible to secure a space for reducing the footprint.

### Supplementary Note 4

The projector according to supplementary note 3, wherein the connection cable is configured to straddle the first surface in the opposing direction.

According to this, it is possible to facilitate the work of connecting the connection cable to the connector.

### Supplementary Note 5

The projector according to supplementary note 3 or supplementary note 4, wherein the sensor is disposed between the first surface and the cover.

According to this, since the sensor is hidden by the cover, the appearance of the projector can be improved.

### Supplementary Note 6

The projector according to any one of supplementary note 1 to supplementary note 5, wherein the main board has an opening section through which a light source wiring electrically connected to the light source is inserted and the connection board is disposed separated from the opening section in plan view.

According to this, it is possible to suppress the adverse effect of static electricity due to the light source wiring.

### Supplementary Note 7

The projector according to any one of supplementary note 1 to supplementary note 6, wherein the connection board is non-flexible.

According to this, since the deflection is suppressed, it is possible to suppress deterioration of the EMI characteristics due to the contact with the electromagnetic interference object.

### Supplementary Note 8

The projector according to any one of supplementary note 1 to supplementary note 6, wherein the connection board has flexibility.

According to this, it is possible to suppress deterioration of the EMI characteristics while achieving a reduction in thickness and weight of the connection board.

### Supplementary Note 9

The projector according to supplementary note 8, wherein the connection board has a shield layer on a surface.

According to this, it is possible to suppress deterioration of the EMI characteristics while achieving a reduction in thickness and weight of the connection board.

What is claimed is:

1. A projector comprising:
a light source;
a driver element configured to control the light source;
an integrated circuit element configured to control the driver element;
a main board on which the integrated circuit element is mounted;
a touch sensor disposed inside an outer peripheral portion of the main board in plan view as viewed from an opposing direction that opposes the main board;
a microcontroller that is disposed adjacent to the touch sensor in plan view and that is configured to control the touch sensor;
a connector that is disposed on the main board at a position closer to the outer peripheral portion than the microcontroller in plan view and that is electrically connected to the integrated circuit element; and
a connection board on one end side of which is mounted the microcontroller and that has a connection cable on the other end side thereof to which is connected the connector, the connection board extending from the one end side toward the connector in plan view, wherein
the connection board is non-flexible, and in plan view, it does not overlap an electromagnetic interference object mounted on the main board.

2. The projector according to claim 1, wherein
the connection board has
a first portion on which the microcontroller is mounted on the one end side and that extends from the one end side toward the connector and
a second portion that extends from a tip end of the first portion along the outer peripheral portion in a direction separated from the connector and that has the connection cable at a tip end thereof.

3. The projector according to claim 1, further comprising:
a housing that is configured to house at least the main board and that has a first surface disposed separated from the main board in the opposing direction and
a cover configured to cover the first surface, wherein
the connection board is disposed between the first surface and the cover.

4. The projector according to claim 3, wherein
the connection cable is configured to straddle the first surface in the opposing direction.

5. The projector according to claim 3, wherein
the touch sensor is disposed between the first surface and the cover.

6. The projector according to claim 1, wherein
the main board has an opening section through which a light source wiring electrically connected to the light source is inserted and
the connection board is disposed separated from the opening section in plan view.

7. The projector according to claim 1, wherein
the connection board has a shield layer on a surface.
